(19) United States
(12) Patent Application Publication
(10) Pub. No.: US 2013/0219782 A1
(43) Pub. Date: Aug. 29, 2013

(54) PLANT PROTECTOR

(71) Applicant: Dianna L Workman, Clive, IA (US)

(72) Inventor: Dianna L Workman, Clive, IA (US)

(21) Appl. No.: 13/407,932

(22) Filed: Feb. 29, 2012

(51) Int. Cl. A01G 13/02

(52) U.S. Cl. 47/30

(57) ABSTRACT

A system for protecting plants. The system has a plurality of walls having sides with sets of offset keepers. Connecting rods are provided through the keepers of adjacent walls and inserted into the ground. The walls have mesh bodies and mesh heads which may be angled inward to prevent animals and pests from gaining access to the interior of the plant protector through the top. Any desired number of walls may be connected to provide any desired configuration of plant protector, and the walls may be provided with openings of various sizes to thwart various sized pests.

### TECHNICAL FIELD

The disclosed embodiments relate generally to plant protection and, in particular, protecting plants from animal, insect and weather damage.

### BACKGROUND

Conventional plant covers provide a mesh cover over plants, allowing air, moisture and light to come into contact with the plants, while preventing animals and insects from damaging the plants. Some gardeners use chicken wire or fencing to surround the plants. One drawback associated with such prior art devices is the difficulty in maintaining the fences in an upright position. Another drawback associated with such prior art devices is the ability of animals to move the fencing. Yet another drawback associated with such prior art devices is the ability of animals to go over or under the fencing to gain access to the plants. It would be desirable, therefore, to provide a light, portable plant protector which may be easily constructed around a plant and which does not allow an animal to move the protector or to easily gain access to the plant, either over or under the protector.

### SUMMARY OF THE DISCLOSED SUBJECT MATTER

The present invention includes devices and methods for protecting plants from animal, insect and weather damage. A plant protector is provided with four walls. Each wall is provided with a mesh body and a mesh head. The mesh heads are tapered and angled inward relative to the bodies. The walls are each provided with a plurality of keepers, with the sides of the walls coupled to one another by connecting rods extending through the keepers. The keepers are offset from one another to provide stability to the plant protector. The connectors extend into the ground to prevent the plant protector from being dislodged by an animal or the elements.

### BRIEF DESCRIPTION OF THE DRAWINGS

The present invention will now be described, by way of example, with reference to the accompanying drawings in which:

FIG. 1 is a top perspective view of the plant protector in accordance with one embodiment;

FIG. 2 is a side elevation of a first wall of the plant protector in accordance with one embodiment;

FIG. 3 is a side elevation of a second wall of the plant protector in accordance with one embodiment;

FIG. 4 is a side elevation of a third wall of the plant protector in accordance with one embodiment;

FIG. 5 is a side elevation of a fourth wall of the plant protector in accordance with one embodiment;

FIG. 6 is a side elevation of a connecting rod in accordance with one embodiment;

FIG. 7 is a top elevation of a keeper in accordance with one embodiment;

FIG. 8 is an alternative embodiment of the present invention, constructed with three walls;

FIG. 9 is an alternative embodiment of the present invention, constructed with six walls;

FIG. 10 is an alternative embodiment of the present invention, provided with a mesh insect covering; and

FIG. 11 is an alternative embodiment of the present invention, provided with a weather covering.

### DETAILED DESCRIPTION OF THE DRAWINGS

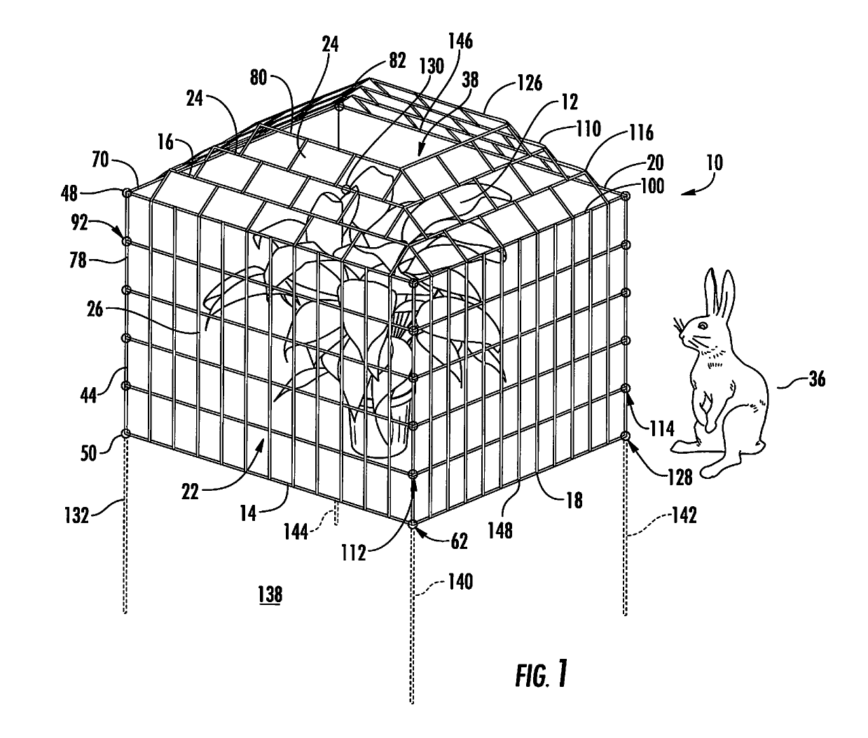

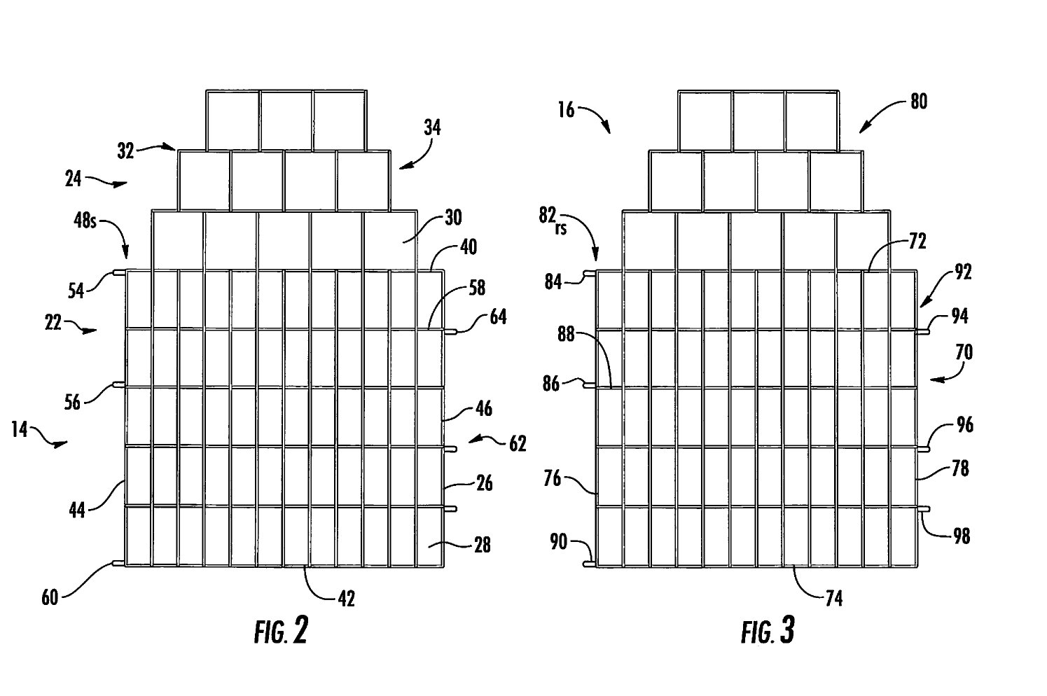

As shown in FIG. 1, a plant protector (10) is provided over a plant (12), such as a flower, tree, shrub, bush or any desired type of plant. The plant protector (10) has a first wall (14), a second wall (16), a third wall (18) and a fourth wall (20). As shown in FIG. 2 the first wall (14) has a mesh body (22) secured to a mesh head (24). The mesh head (24) is preferably between 5.0 and 25.0 centimeters high, more preferably between 10.0 and 15.0 centimeters high, and most preferably about 12.7 centimeters high. The mesh body (22) has a height and width preferably between 5.0 and 100 centimeters, more preferably between 20.0 and 50.0 centimeters, and most preferably 30.5 centimeters, but may be constructed of any desired size or configuration. While the mesh body (22) and mesh head (24) may be constructed of any desired materials, in the preferred embodiment they are constructed of vinyl-coated galvanized steel wire (26), defining a plurality of openings (28) and (30). Alternatively, the steel wire may be powder-coated in a manner such as that known in the art. In the preferred embodiment, the wire (26) is preferably between 1.0 and 40.0 gauge (AWG), more preferably between 5.0 and 20.0 gauge (AWG), and most preferably between 9.0 and 14.0 gauge (AWG).

The mesh head (24) may be integrally formed with the mesh body (22) or, alternatively, may be welded or otherwise secured thereto. Preferably the openings (30) in the mesh head (24) are larger than the openings (28) in the mesh body (22). The openings in the mesh head (24) are preferably provided with a height and width between 1.0 millimeter and 100.0 millimeters, and more preferably between 10.0 millimeters and 70.0 millimeters. As shown in FIG. 2, the openings (30) of the mesh head (24) are approximately 50.8 millimeters wide by 50.8 millimeters high. The mesh head (24) is preferably stepped along its sides (32) and (34), but may, if desired, be provided with smoothly tapered sides defining irregularly shaped openings along the sides (32) and (34) of the mesh head (24). As shown in FIG. 1, the mesh head (24) is angled inward relative to the mesh body (22) to protect the plant (12) from animals (36) attempting to jump over the first wall (14) into the interior (38) of the plant protector (10) where the plant (12) is located. As shown in FIG. 2, the mesh head (24) is secured to a top (40) of the first wall (14). The first wall (14) is also provided with a bottom (42), a first side (44) and a second side (46). Provided along the first side (44) are a plurality of keepers (48).

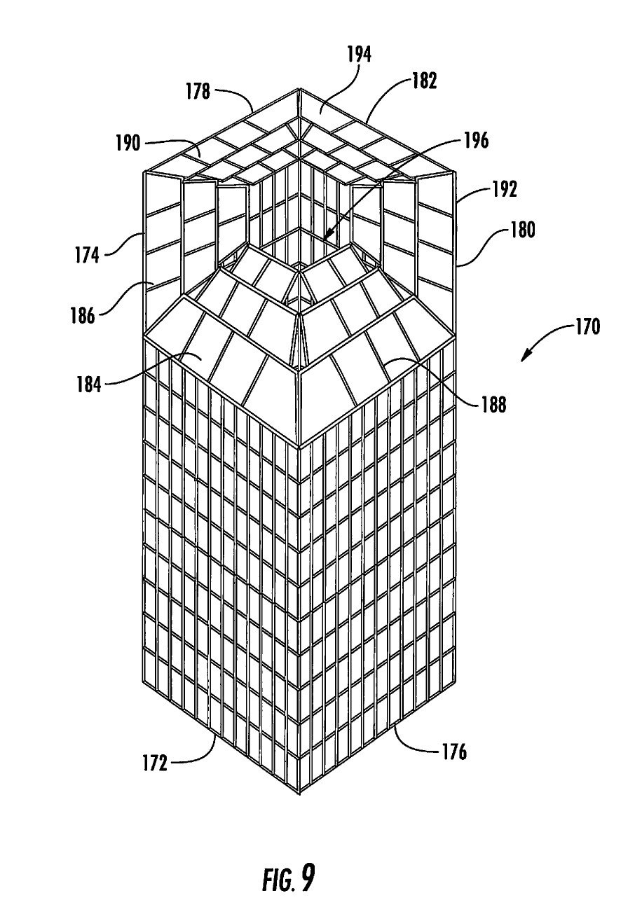

As shown in FIG. 7, each keeper is a loop (50) defined by wire (52) extending beyond the first side (44) of the mesh body (22). The keeper may be an integral loop, a welded loop, a closed loop (50) or an open loop, such as a hook. Alternatively, the first plurality of keepers (48) may be provided interior of the first side (44) of the mesh body (22).

As shown in FIG. 2, the first side (44) provides a first keeper (54) at the top (40) of the mesh body (22), a second keeper (56), two rows of crossbars (58) down from the first keeper, (54) and a third keeper (60) along the bottom (42) of the mesh body (22). As shown, the keepers (54), (56) and (60) are aligned with their respective crossbars (58) to provide added support and to use, if desired, a length of the crossbars (58) extending beyond the first side (44) of the mesh body (22) to be formed into the shape of the keepers (54), (56) and (60).

Shown along the second side (46) of the mesh body (22) are a second plurality of keepers (62). The second plurality of keepers (62) is offset from the first plurality of keepers (48). As shown, the first keeper (64) on the second side (46) is positioned along the second crossbar (58) from the top (40) of the mesh body (22). The second keeper (66) along the second side (46) is positioned along the third crossbar (58) from the bottom (42) of the mesh body (22), and the third keeper (68) is located at the second crossbar (58) from the bottom (42) of the mesh body (22). The second plurality of keepers (62) is offset from the first plurality of keepers (48) to prevent keepers from interfering with one another when the walls (14), (16), (18) and (20) are joined together. Preferably, the first plurality of keepers (48) has at least one keeper (54) located at the top (40) of the mesh body (22), and at least one keeper (60) located at the bottom (42) of the mesh body (22) to increase the stability of the plant protector (10) when the walls (14), (16), (18) and (20) are secured to one another.

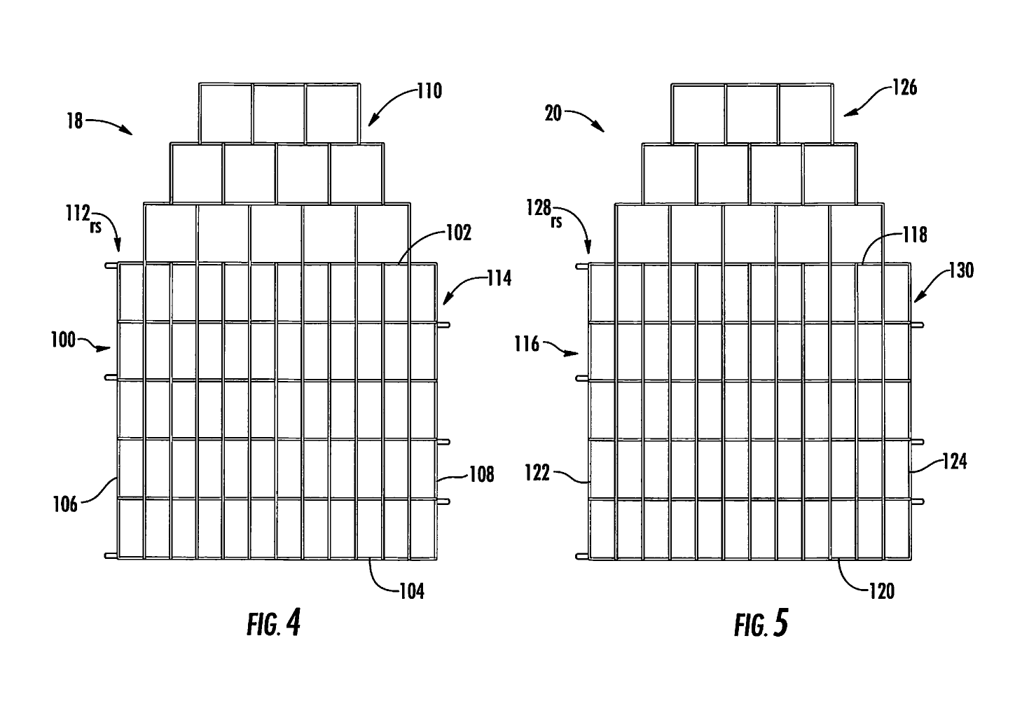

As shown in FIG. 3, the second wall (16) is provided with a mesh body (70) having a top (72), bottom (74), first side (76) and second side (78) of a construction similar to that described in association with the first wall (14). Integrally formed with or otherwise secured to the top (72) of the mesh body (70) is a mesh head (80) of a construction similar to that described above in association with the mesh head (24) of the first wall (14).

Provided along the first side (76) are a third plurality of keepers (82), oriented in a manner such as that described above in association with the first plurality of keepers (48) of the first wall (14). The first keeper (84) is provided along the top (72) of the mesh body (70), the second keeper (86) is provided along the second row of crossbars (88) down from the top (72), and the third keeper (90) is provided along the bottom (74) of the mesh body (70). Provided along the second side (78) of the mesh body (70) is a fourth plurality of keepers (92). These keepers (94), (96) and (98) are provided in an orientation similar to that described above in association with the second side (46) of the first wall of the mesh body (22). The third wall (18) is shown in FIG. 4. The third wall (18) is provided with a mesh body (100) having a top (102), a bottom (104), a first side (106) and a second side (108). A mesh head (110) such as that described above is provided integral with or otherwise secured to the top (102) of the mesh body (100).

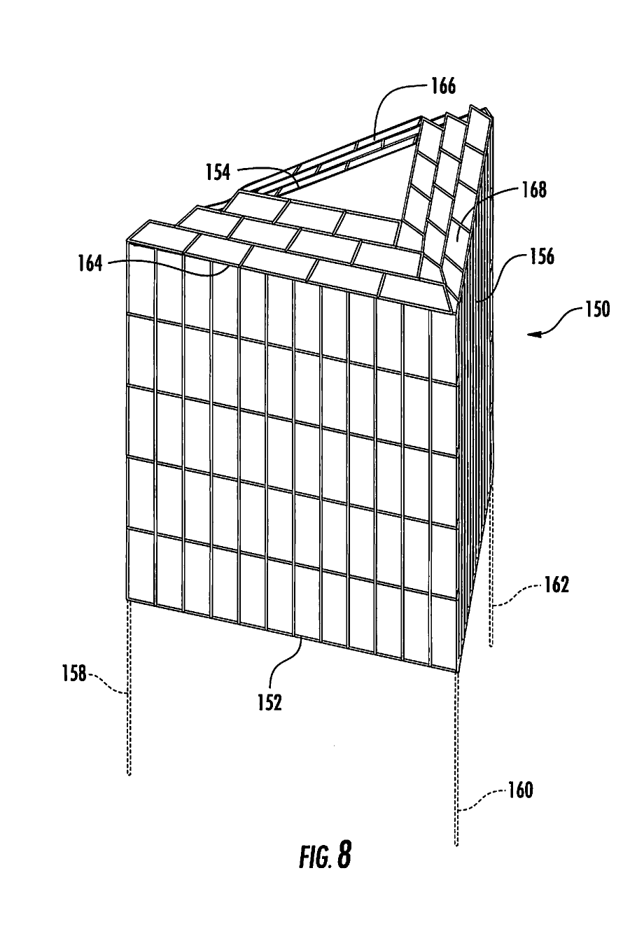

Provided along the first side (106) of the mesh body (100) is a fifth plurality of keepers (112) offset from a sixth plurality of keepers (114) provided along the second side (108) of the mesh body (100). Similarly, as shown in FIG. 6, the fourth wall (20) is provided with a mesh body (116), having a top (118), a bottom (120), a first side (122) and a second side (124). The fourth wall (20) is also provided with a mesh head (126) integrally secured to the top (118) of the mesh body (116). Provided along the first side (122) of the mesh body (116) is a seventh plurality of keepers (128) offset from an eighth plurality of keepers (130) provided along the second side (124) of the mesh body (116) in a manner such as that described above.

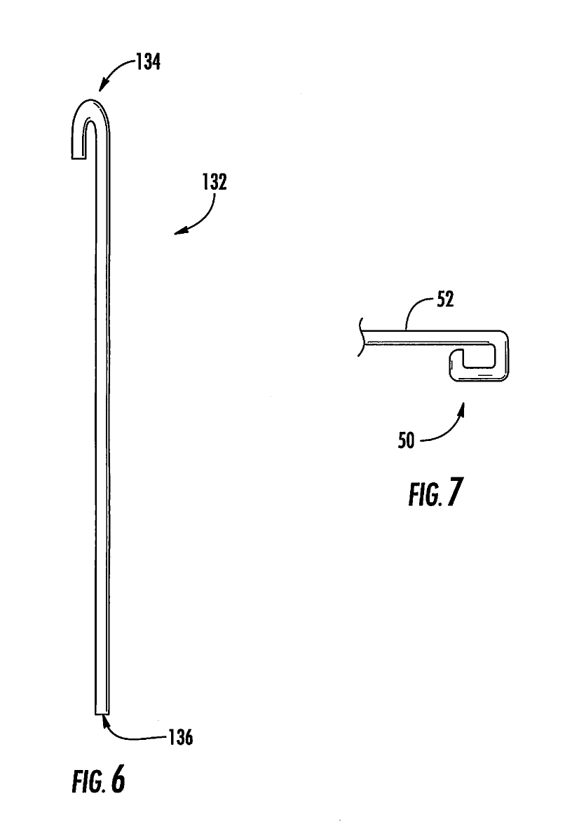

To construct the plant protector (10), the first side (44) of the first wall (14) is positioned near the fourth wall near the second side (78) of the second wall (16). (FIG. 1). As shown in FIGS. 4 and 5, the first plurality of keepers provided along the first side (44) of the first wall (14) is offset from the fourth plurality of keepers (92) provided along the second side (78) of the second wall (16). This offset allows the first plurality of keepers (48) and fourth plurality of keepers (92) to be aligned, allowing for the provision of a connecting rod (132) through the first plurality of keepers (48) and fourth plurality of keepers (92).

As shown in FIGS. 1 and 6, the connecting rod (132) is preferably a galvanized steel rod between two millimeters and twenty millimeters in diameter, and having a length between ten percent and two hundred percent the length of the first side (44) of the mesh body (22) of the first wall (14). The connecting rod (132) is preferably 4.0 to 6.35 millimeters in diameter. The connecting rod (132) is provided with a top (134) and a bottom (136). Preferably the bottom (136) is flat or blunt, but it may be tapered or pointed for hard ground. The top (134) is not pointed to allow the connecting rod (132) to be pushed into the ground by hand or driven into the ground by a hammer (not shown) or similar instrument. As shown, the top (134) of the connecting rod (132) is curved to not only allow the connecting rod (132) to be driven into the ground, but also to secure the connecting rod (132) to the first keeper (54) to prevent inadvertent dislodgement therefrom.

The first side (44) of the mesh body (22) of the first wall (14) is preferably 22.9 centimeters in length and the connecting rod (132) is preferably 40.6 centimeters in length, allowing for 15.2 centimeters of the connecting rod (132) to extend below the ground (138) when the plant protector (10) is in use. The connecting rod (132) may be positioned within the first plurality of keepers (48) and fourth plurality of keepers (92) before placing the first wall (14) and second wall (16) on the ground. Preferably, the first wall (14) and second wall (16) are positioned as desired around the plant (12) and the connecting rod (132) is threaded through the first plurality of keepers (48) and fourth plurality of keepers (92) into the ground (138). The connecting rod (132) may either be pushed into the ground (138) by hand or driven into the ground (138) using a hammer (not shown) or similar device. The diameter of the loops (50) associated with the first plurality of keepers (48) and fourth plurality of keepers (92) may be of any desired dimensions, but are preferably slightly larger than the diameter of the connecting rod (132).

Once the first wall (14) has been secured to the second wall (16) by the connecting rod (132), the third wall (18) is positioned near the first wall (14) with the second plurality of keepers (62) aligned with the fifth plurality of keepers (112). A second connecting rod (140) is provided through the second plurality of keepers (62) and fifth plurality of keepers (112) and driven into the ground in a manner such as that described above. Preferably, in the preferred embodiment, the first wall (14), second wall (16) and third wall (18) are provided right angles to one another to maximize the interior space within the plant protector (10). If desired, the walls (14), (16), (18) and (20) may be provided at any desired angle to create different shapes, such as a parallelogram if desired.

Once the second wall (16) and third wall (18) have been positioned as desired, the fourth wall (20) is positioned to place the seventh plurality of keepers (128) in alignment with the sixth plurality of keepers (114). A third connecting rod (142) is threaded through the sixth plurality of keepers (114) and seventh plurality of keepers (128) into the ground (138) to secure the fourth wall (20) to the third wall (18). The eighth plurality of keepers (130) associated with the fourth wall (20) is aligned with the third plurality of keepers (82) associated with the second wall (16) and a fourth connecting rod (144) is threaded through the third plurality of keepers (82) and eighth plurality of keepers (130) into the ground (138) to secure the second wall (16) and fourth wall (20) in place.

Once the walls (14), (16), (18) and (20) have been secured by the connecting rods (132), (140), (142) and (144), the mesh heads (24), (80), (110) and (126) are angled inward to define a smaller opening (146) in the plant protector (10) than the perimeter (148) along the ground (138) defined by the mesh bodies (22), (70), (100) and (116). If desired, the mesh heads (24), (80), (110) and (126) may be angled so they contact one another secured to one another. When it is desired to move the plant protector (10), the connecting rods (132), (140), (142) and (144) are removed from the ground (138). If desired, the mesh heads (24), (80), (110) and (126) may be bent parallel with the mesh bodies (22), (70), (100) and (116) for storage.

An alternative embodiment of the present invention is shown generally as (150) in FIG. 8. In this alternative embodiment of the plant protector (150), the plant protector is provided with three sides (152), (154) and (156), secured to one another by three connecting rods (158), (160) and (162) in a manner such as that described above. The sides (152), (154) and (156) may be of a dimension similar to that described above in association with the walls (14), (16), (18) an (20), or may be modified to allow for the mesh heads (164), (166) and (168) to fold lower than would be allowed with the mesh heads (24), (80), (110) and (126) described above.

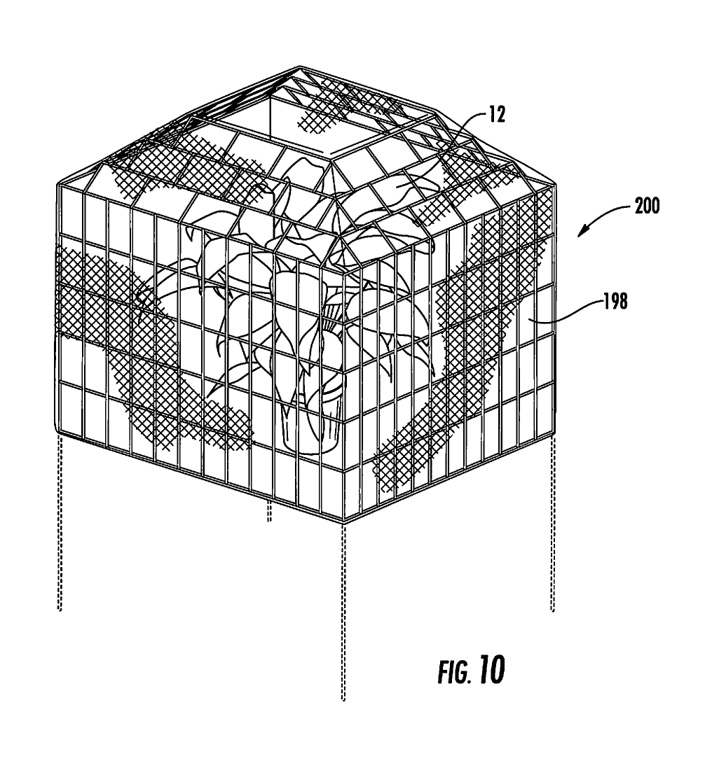

In another alternative embodiment of the present invention shown generally as (170) in FIG. 9, the plant protector (170) is provided with six sides (172), (174), (176), (178), (180) and (182) to define a hexagonal plant protector (170). As noted above, the mesh heads (184), (186), (188), (190), (192) and (194) may be of any desired construction to provide the plant protector (170) with any desired top (196).

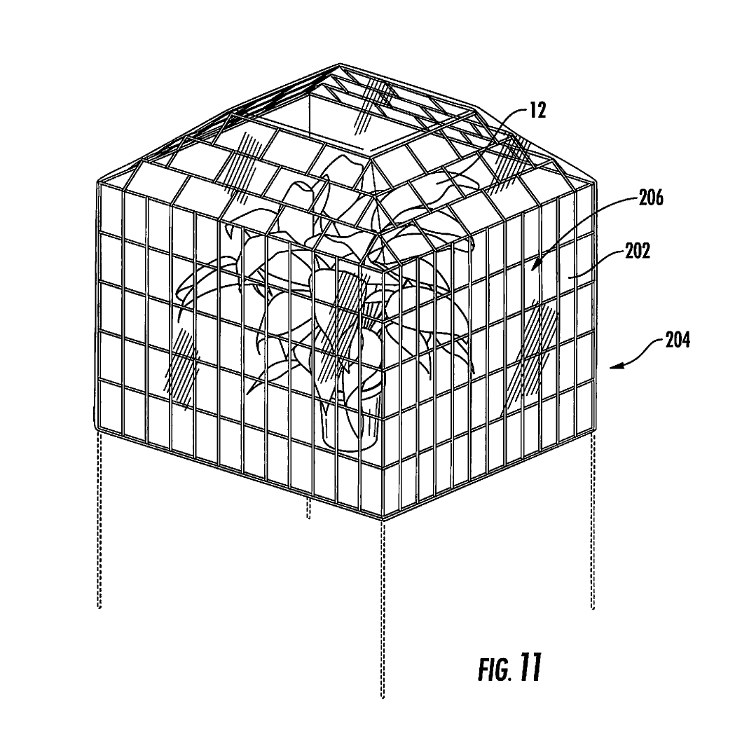

Shown in FIG. 10 is an alternative embodiment of the present invention having an insect net (198) constructed of any desired insect resistant material, such as mosquito netting, or any other material known in the art and provided over the plant protector (200).

Another alternative embodiment of the present invention is shown in FIG. 11. An insulating material, such as a flexible polyethylene insulation (202) such as that known in the art, is formed into the shape of the plant protector (204) to protect plants (206) contained therein from frost damage. Although the insulation (202) may be constructed with any desired material and provided in any desired configuration, in the preferred embodiment the insulation (202) is waterproof, at least partially transparent, and retards the loss of heat through the insulation (202), but may be constructed of any suitable insulative or waterproof material known in the art.

Although the invention has been described with respect to a preferred embodiment thereof, it is to be understood that it is not to be so limited since changes and modifications can be made therein which are within the full, intended scope of this invention as defined by the appended claims.

What is claimed is:

1. A plant protector comprising:
(a) a first wall comprising:
(i) a first mesh body having a first side, a second side, a first top and a first bottom;
(ii) a first mesh head coupled to the top of the first mesh body, wherein the first mesh head is angled inward relative to the first mesh body;
(iii) a first plurality of keepers coupled to the first side of the first mesh body; and
(iv) a second plurality of keepers coupled to the second side of the first mesh body;
(b) a second wall comprising:
(i) a second mesh body having a first side and a second side, a second top and a second bottom;
(ii) a second mesh head coupled to the top of the second mesh body, wherein the second mesh head is angled inward relative to the second mesh body;
(iii) a third plurality of keepers coupled to the first side of the second mesh body; and
(iv) a fourth plurality of keepers coupled to the second side of the second mesh body;
(c) a first connecting rod coupling the first plurality of keepers to the fourth plurality of keepers;
(d) wherein the first plurality of keepers is offset from the fourth plurality of keepers;
(e) a second connecting rod coupled to the second plurality of keepers; and
(f) a third connecting rod coupled to the third plurality of keepers.

2. The plant protector of claim 1, further comprising:
(a) a third wall comprising:
(i) a third mesh body having a first side and a second side, a third top and a third bottom;
(ii) a third mesh head coupled to the top of the third mesh body, wherein the third mesh head is angled inward relative to the third mesh body;
(iii) a fifth plurality of keepers coupled to the first side of the third mesh body; and
(iv) a sixth plurality of keepers coupled to the second side of the third mesh body;
(b) wherein the second connecting rod is coupled to the fifth plurality of keepers; and
(c) wherein the second plurality of keepers is offset from the fifth plurality of keepers.

3. The plant protector of claim 2, wherein the third connecting rod is coupled to the sixth plurality of keepers.

4. The plant protector of claim 2, further comprising a fourth connecting rod coupled to the sixth plurality of keepers.

5. The plant protector of claim 2, further comprising:
(a) a fourth wall comprising:
(i) a fourth mesh body having a first side and a second side, a fourth top and a fourth bottom;
(ii) a fourth mesh head coupled to the top of the fourth mesh body, wherein the fourth mesh head is angled inward relative to the fourth mesh body;
(iii) a seventh plurality of keepers coupled to the first side of the fourth mesh body; and
(iv) an eighth plurality of keepers coupled to the second side of the fourth mesh body;
(b) wherein the third connecting rod is coupled to the eighth plurality of keepers; and
(c) wherein the third plurality of keepers is offset from the eighth plurality of keepers.

6. The plant protector of claim 5, wherein the first mesh head, the second mesh head, the third mesh head, and the fourth mesh head define a top opening larger than the majority of openings defined by the first mesh head, and smaller than a perimeter defined by the first bottom, the second bottom, the third bottom and the fourth bottom.

7. The plant protector of claim 5, further comprising a fourth connecting rod coupled to the sixth plurality of keepers.

8. The plant protector of claim 7, wherein the fourth connecting rod is coupled to the seventh plurality of keepers.

9. The plant protector of claim 1, wherein the first set of keepers comprises a top keeper and a bottom keeper, wherein no keeper of the second set of keepers is closer to the first top of the first mesh wall than the top keeper and wherein no keeper of the second set of keepers is closer to the first bottom of the first mesh wall than the bottom keeper.

10. The plant protector of claim 1, wherein
(a) the first connecting rod comprises a top and a bottom;
(b) the bottom of the first connecting rod is flat;
(c) the top of the first connecting rod is curved;
(d) the second connecting rod comprises a top and a bottom;
(e) the bottom of the second connecting rod is flat; and
(f) the top of the second connecting rod is curved.

11. The plant protector of claim 10, wherein the first connecting rod is at least fifty percent longer than the first side of the first mesh body.

12. The plant protector of claim 10, wherein the first connecting rod is at least twenty-five percent longer than the first side of the first mesh body.

13. The plant protector of claim 1, wherein the mesh of the first mesh body defines a majority of openings smaller than the majority of openings defined by the first mesh head.

14. The plant protector of claim 1, wherein the first mesh head is provided with a top and a bottom, wherein the bottom of the first mesh head is coupled to the first top, and wherein the distance between the first top and the top of the first mesh head is less than the distance between the first top and the first bottom.

15. The plant protector of claim 1, wherein the first mesh head is tapered and is cantilevered toward the second mesh head.

16. A plant protector comprising:
(a) a first wall comprising:
(i) a first mesh body having a first side, a second side, a first top and a first bottom;
(ii) a first mesh head coupled to the top of the first mesh body, wherein the first mesh head is angled inward relative to the first mesh body;
(iii) a first plurality of keepers coupled to the first side of the first mesh body; and
(iv) a second plurality of keepers coupled to the second side of the first mesh body;
(b) a second wall comprising:
(i) a second mesh body having a first side and a second side, a second top and a second bottom;
(ii) a second mesh head coupled to the top of the second mesh body, wherein the second mesh head is angled inward relative to the second mesh body;
(iii) a third plurality of keepers coupled to the first side of the second mesh body; and
(iv) a fourth plurality of keepers coupled to the second side of the second mesh body;
(c) a third wall comprising:
(i) a third mesh body having a first side and a second side, a third top and a third bottom;
(ii) a third mesh head coupled to the top of the third mesh body, wherein the third mesh head is angled inward relative to the third mesh body;
(iii) a fifth plurality of keepers coupled to the first side of the third mesh body; and
(iv) a sixth plurality of keepers coupled to the second side of the third mesh body;
(d) a first connecting rod coupling the first plurality of keepers to the fourth plurality of keepers;
(e) wherein the first connecting rod is at least fifty percent longer than the first side of the first mesh body;
(f) wherein the first plurality of keepers is offset from the fourth plurality of keepers;
(g) a second connecting rod coupling the second plurality of keepers to the fifth plurality of keepers;
(h) wherein the second connecting rod is at least twenty percent longer than the fifth side of the third mesh body; and
(i) wherein the second plurality of keepers is offset from the fifth plurality of keepers.

17. The plant protector of claim 16, wherein
(a) the first connecting rod comprises a top and a bottom;
(b) the top of the first connecting rod is curved;
(c) the second connecting rod comprises a top and a bottom; and
(d) wherein the top of the second connecting rod is curved.

18. The plant protector of claim 17, wherein the mesh of the first mesh body defines a majority of openings smaller than the majority of openings defined by the first mesh head.

19. A plant protector comprising:
(a) a first wall comprising:
(i) a first mesh body having a first side, a second side, a first top and a first bottom;
(ii) a first mesh head coupled to the top of the first mesh body, wherein the first mesh head is angled inward relative to the first mesh body;
(iii) a first plurality of keepers coupled to the first side of the first mesh body; and
(iv) a second plurality of keepers coupled to the second side of the first mesh body;
(b) a second wall comprising:
(i) a second mesh body having a first side and a second side, a second top and a second bottom;
(ii) a second mesh head coupled to the top of the second mesh body, wherein the second mesh head is angled inward relative to the second mesh body;
(iii) a third plurality of keepers coupled to the first side of the second mesh body; and
(iv) a fourth plurality of keepers coupled to the second side of the second mesh body;
(c) a third wall comprising:
(i) a third mesh body having a first side and a second side, a third top and a third bottom;
(ii) a third mesh head coupled to the top of the third mesh body, wherein the third mesh head is angled inward relative to the third mesh body;
(iii) a fifth plurality of keepers coupled to the first side of the third mesh body; and
(iv) a sixth plurality of keepers coupled to the second side of the third mesh body:
(d) a fourth wall comprising:
(i) a fourth mesh body having a first side and a second side, a fourth top and a fourth bottom;
(ii) a fourth mesh head coupled to the top of the fourth mesh body, wherein the fourth mesh head is angled inward relative to the fourth mesh body;
(iii) a seventh plurality of keepers coupled to the fourth side of the fourth mesh body; and
(iv) an eighth plurality of keepers coupled to the fourth side of the fourth mesh body;
(e) a first connecting rod coupling the first plurality of keepers to the fourth plurality of keepers;
(f) wherein the first plurality of keepers is offset from the fourth plurality of keepers;
(g) a second connecting rod coupling the second plurality of keepers to the fifth plurality of keepers;
(h) wherein the second plurality of keepers is offset from the fifth plurality of keepers;
(i) a third connecting rod coupling the third plurality of keepers to the eighth plurality of keepers;
(j) wherein the third plurality of keepers is offset from the eighth plurality of keepers;
(k) a fourth connecting rod coupling the sixth plurality of keepers to the seventh plurality of keepers; and
(l) wherein the sixth plurality of keepers are offset from the seventh plurality of keepers.

20. The plant protector of claim 19, wherein the first plurality of keepers is a plurality of wire loops.
